(19) United States
(12) Patent Application Publication
(10) Pub. No.: US 2003/0037303 A1
(43) Pub. Date: Feb. 20, 2003

(54) Method of and system for updating a document

(76) Inventors: Maarten Peter Bodlaender, Eindhoven (NL); Nicolaas Willem Schellingerhout, Eindhoven (NL); Catharina Ibrahim, Eindhoven (NL); Honest Christopher Kimaro, Dar es Salaam (TZ)

Correspondence Address: U.S. Philips Corporation, 580 White Plains Road, Tarrytown, NY, 10591, US

(21) Appl. No.: 10/208,675

(22) Filed: Jul. 30, 2002

(30) Foreign Application Priority Data
Aug. 3, 2001 (EP) 01202946.8

(51) Int. Cl. G06F 15/00

(52) U.S. Cl. 715/523

(57) ABSTRACT

The Extensible Markup Language (XML) is a recommended World Wide Web Consortium (W3C) specification to exchange structured data over the Internet. XML is a simplified subset of Standard Generalized Markup Language (SGML). To accommodate human-computer interaction, technologies are needed to provide proper visualization and manipulation of XML documents. There is provided a method and a system that enables editing of a visualized document and enables inverting this visualized document into its original format.

The invention relates to a method of updating a first document in a first format, the method comprising:

converting the first document in the first format into a second document in a second format;

displaying the second document to a user, wherein the second document is a visualization of the first document.

Furthermore the invention relates to a system of updating a first document of a first format, the system comprising:

converting means conceived to convert the first document of the first format into a second document of a second format, wherein the second document is a visualization of the first document.

An embodiment of the method and system as set forth above is known from WO 00/20985. Here, a method is disclosed that converts a document in an input format into a document in a different output format. The method comprises locating data in the input document, grouping data into one or more intermediate format blocks in an intermediate format document and converting the intermediate format document to the output format document using the intermediate format blocks. Each intermediate format block may be a paragraph, a line, a word, a table or an image. The output document can be displayed by locating sub-page breaks in the document, subdividing the document into sub-pages using the sub-pages breaks, locating blocks within each sub-page, and sequentially displaying all or a portion of each block of the sub pages within display parameters of a display configuration. Each of the input format and output format can be amongst others, hypertext markup language (HTML), and extensible markup language (XML). When, for example a document is in the HTML format, the visualization of the document is according to the interpretation of the HTML comprised within the document. This document can then translated into an XML document which is visualized accordingly. To enable a user to update the original document, the user updates the input document as plain ASCII text, and can only view the more sophisticated visualization of the update after visualization of the input document.

It is an object of the current invention to provide a method that allows a user to update a document in an improved way. To achieve this object, the method according to the preamble is characterized in that the method further comprises

editing the second document by performing a user interaction with the document;

updating the second document of the second format with the user interaction; and

reconverting the updated second document into an updated first document by inverting the updated second document.

By allowing a user to perform the updates upon the more sophisticated graphical representation of the original document, the user can directly manipulate the more sophisticated graphical representation and view the result of the manipulation directly. Thus, there's no need for an additional translation in order to view the consequences of the update to the layout of the document. However, since the updates must be effectuated into the original, first document, the method comprises a step that reconverts the updated graphical representation of the original document into the format of the original, first document, thereby providing a more intuitive update of the first document.

An embodiment of the method according to the invention is described in claim 2. The visualized, second, document can allow all possible user interactions that can be performed upon the visualization of the first document. However, the first document can define additional rules to which a graphical representation must adhere. For example: the first document describes edges and vertices and has an additional rule that describes that each vertex must be connected via an edge to an other vertex. The second document can then visualize the vertices and edges, and can allow deletion of, for example an edge such that not all vertices are connected via an edge to an other vertex. Then, the method according to the invention checks, upon reconverting the second document, that each vertex is connected via an edge to an other vertex and, according to the chosen policy of dealing with errors can omit those vertices and edges that do not adhere to this rule. It is also possible, that the changes are included which results into an incorrect first document. In this case the incorrect first document can be presented to the user as a “draft” document, which is not valid and allow the user to repair the errors or apply an algorithm to repair the document. Other repair strategies are also possible that result into a well-formed inverted document.

An embodiment of the method according to the invention is described in claim 3. By presenting to a user only the allowed updates to the second document that adhere to the additional rules the reconverted document does not contain updates that can lead to a violation of the additional rules. This can for example be achieved by providing to a user only an option to add an edge between two vertices and not to allow addition of edges that are not connected to at least two vertices. The options can be presented to the user through a dedicated user interface.

Embodiments of the method according to the invention are described in claims 4 to 6.

Furthermore, it is an object of the current invention to provide a system that allows a user to update a document in an improved way. To achieve this object, the system according to the preamble is characterized in that the system further comprises

updating means conceived to update the second document of the second format according to the user interaction; and

re-conversion means conceived to reconvert the updated second document into the first document by inverting the updated second document.

The invention will be described by means of embodiments illustrated by the following drawings:

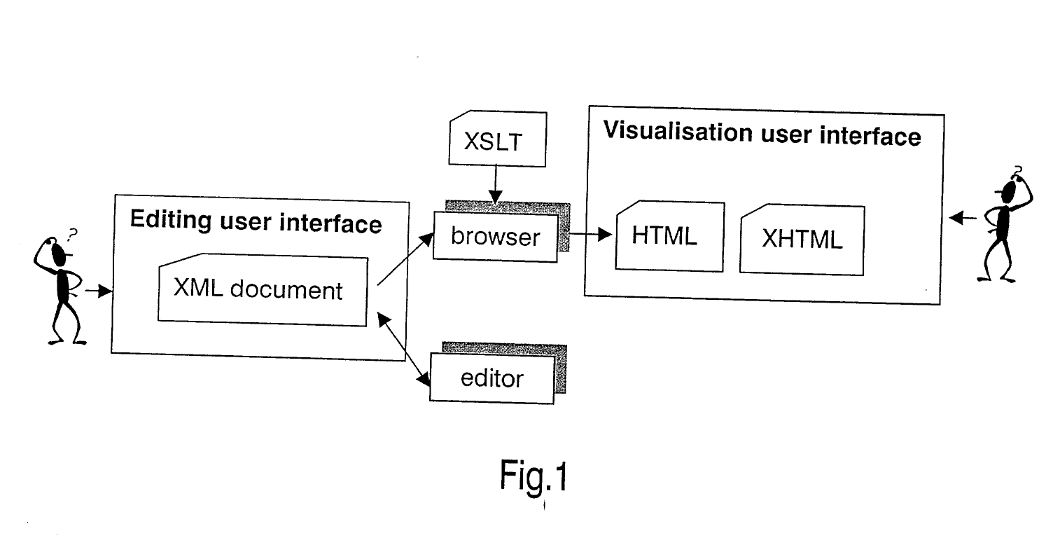

FIG. 1 illustrates a separation of editing and visualization of a document;

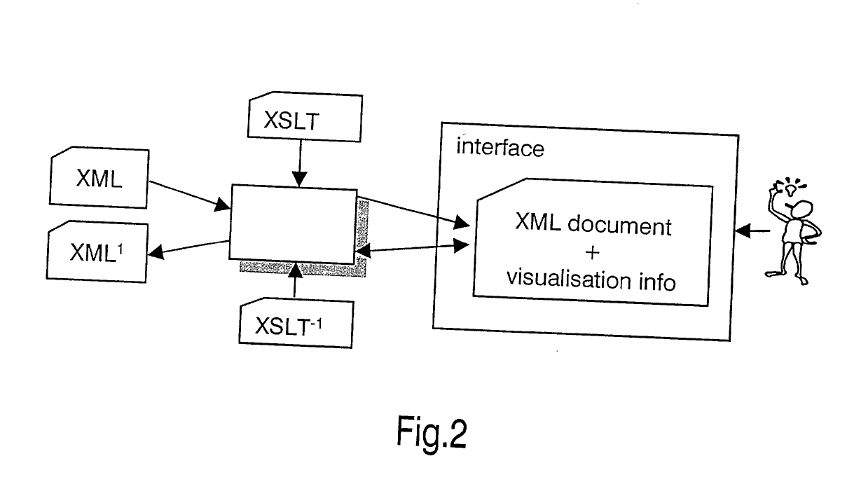

FIG. 2 illustrates a general overview of the main steps of the method according to the invention;

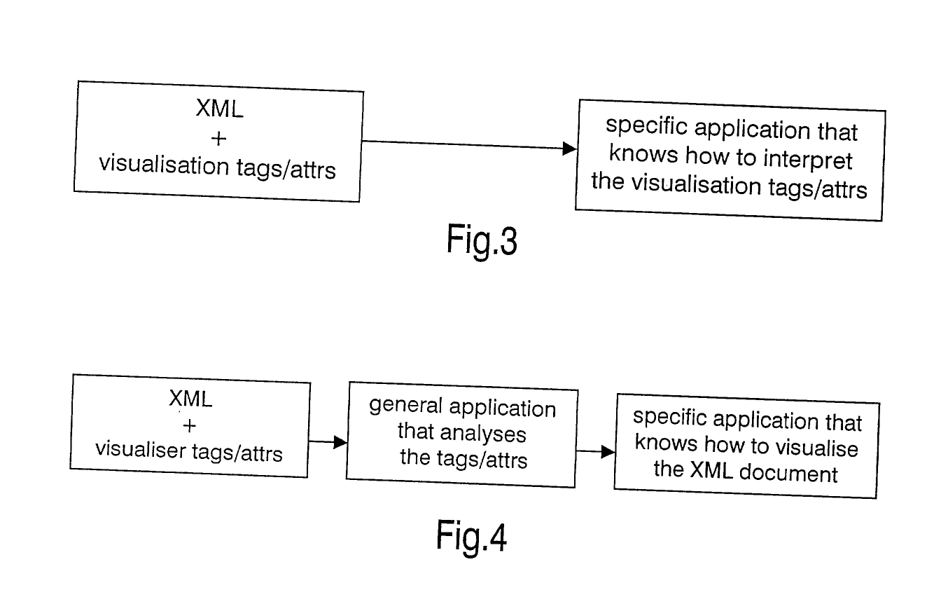

FIG. 3 illustrates a representation of a document to a user;

FIG. 4, illustrates a user interface that supports preventing an illegal edit;

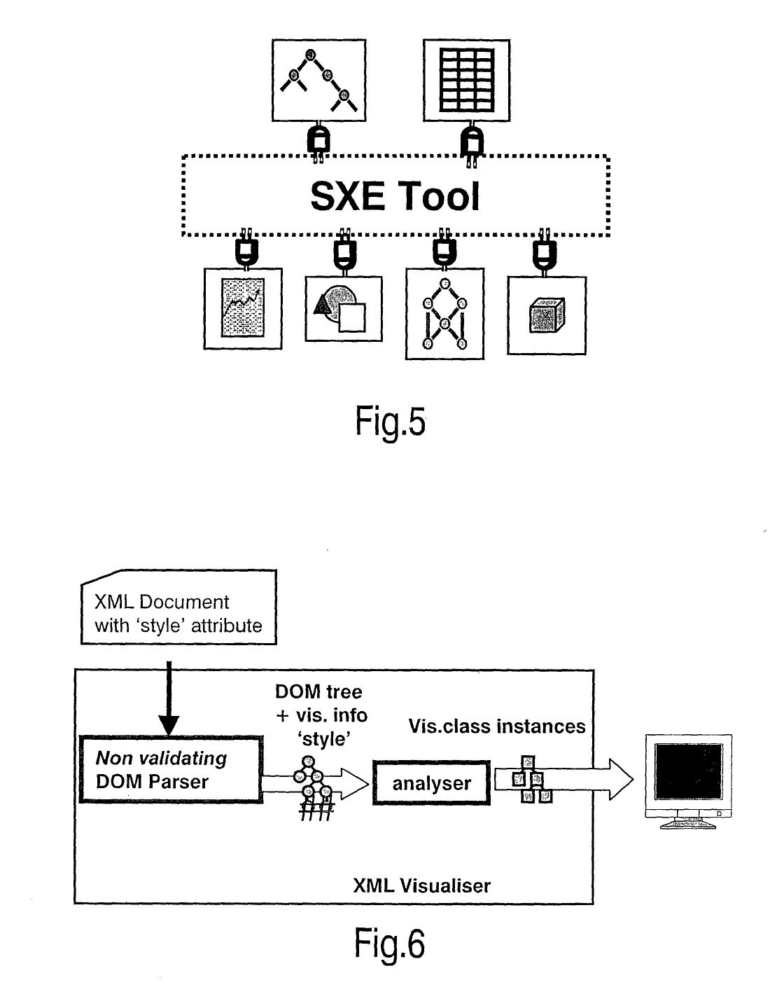

FIG. 5 illustrates visual feedback of an invalid situation to a user;

FIG. 6 illustrates construction of an in-memory document.

As illustrated in FIG. 1, the attempt to maintain a clean XML document results in a separate visualisation user interface 100 and editing user interface 102. The editing user interface 102 serves as the access point to the clean XML document 104. Since the editing takes place in the XML document 104 without any visualisation information, there is no attractive visualisation. The content is commonly given as plain text or as a tree-view view. This is not intuitive since it does not give immediate understanding of what the XML content is about. The visualisation of the XML document can be achieved by displaying the XML document 104 through a browser 106 like Netscape Communicator or Microsoft Internet Explorer. In order to display the XML document 104, a style sheet 108, for example described as an Extensible Stylesheet Language Transformation (XSLT), is used. XSLT is an extension of the Extensible Stylesheet Language (XSL). XSL is a language for formatting an XML document. For example, showing how the data described in the XML document should be presented in a Web page. XSLT shows how the XML document should be reorganized into another data structure, which could then be presented by following an XSL stylesheet.

As an illustration of unintuitive editing, consider an XML document that contains a graph description. It is not easy to understand and picture a graph that is viewed in a tree-view that lists the vertices name, the coordinates, and the connecting edge. Because of this, editing the XML document 104 can be difficult. A solution that comprises an integrated user interface can solve this problem of unintuitive visualisation. One solution is to provide a specific XML editor that is able to interpret a specific set of visualisation tags and attributes. Consider Scalable Vector Graphics (SVG) for example. The XSLT augments the XML document with various visualisation tags and attributes that describe how to display the elements as vector graphics. It requires a specific application to understand these tags and attributes of SVG and render the XML document correctly.

Thus, it is more beneficial to have a general purpose XML editor that is able to view many XML documents in various ways, according to what the content of each XML document is about.

FIG. 2, illustrates a general overview of the main steps of the method according to the invention. Here, 200 is the XML document that needs to be edited and 204 is the corresponding style sheet that describes the visualization of the XML document 200. Within step S202, the style sheet 204 is applied to the document 200, which results into a new document 206 showing the visualized XML document 200. Within step S208, the visualized document 206 is edited by a user, which results in an edited visualized document 210. Then, within step S214, an inverse style sheet 212 is applied to the edited visualized document 210 and an edited XML document 216 is extracted from the edited visualized document 210.

The applicable documents are described by the following, non-restrictive, example. Consider the following original document 200 that adheres to a Document Type Definition (DTD).

<?xml version=“1.0”encoding=“UTF-8”?>
<bookOfPoems xmlns:xsi=
“http://www.w3.org/1999/XMLSchema-instance”
xsi:noNamespaceSchemaLocation=“invention.xsd”>

<graph>

<vertex><name>A</name><x>352</x><y>180</y></vertex>
<vertex><name>G</name><x>94</x><y>160</y></vertex>
<vertex><name>B</name><x>377</x><y>159</y></vertex>
<edge><from>A</from><to>B</to></edge>
<edge><from>A</from><to>G</to></edge>

</graph>

</bookOfPoems>

A DTD is a specific definition that follows the rules of the Standard Generalized Markup Language (SGML). For example, the following XML scheme:

<?xml version=“1.0”encoding=“UTF-8”?>
<schema xmlns=“http://www.w3.org/1999/XMLSchema”>

<element name=“bookOfPoems”>

<complexType>

<element ref=“graph”minOccurs=“0”

maxOccurs=“unbounded”/>

</complexType>

</element>
<element name=“graph”>

<complexType>

<element ref=“vertex” minOccurs=“0”

maxOccurs=“unbounded”/>

<element ref=“edge”minOccurs=“0”

maxOccurs=“unbounded”/>

</complexType>

</element>
<element name=“vertex”>

<complexType>

<element ref=“name”minOccurs=“1”maxOccurs=“1”/>
<element ref=“x”minOccurs=“1”maxOccurs=“1”/>
<element ref=“y”minOccurs=“1”maxOccurs=“1”/>

</complexType>

</element>
<element name=“name”type=“string”/>
<element name=“x”type=“integer”/>
<element name=“y”type=“integer”/>
<element name=“edge”>

<complexType>

<element ref=“from”minOccurs=“1”maxOccurs=“1”/>
<element ref=“to”minOccurs=“1”maxOccurs=“1”/>

</complexType>

</element>
<element name=“from”type=“string”/>
<element name=“to”type=“string”/>

</schema>

Then its matching style sheet 204, which transforms the XML document 200 into document 3 comprises:

<?xml version=“1.0”?>
<xsl:stylesheet xmlns:xsl=
“http://www.w3.org/1999/XSL/Transform”version=“1.0”>

<xsl:template match=“bookOfPoems”>

<bookOfPoems xmlns:xsi=“http://www.w3.org/1999/XMLSchema-

instance”style=“VisTabs”>

<xsl:apply-templates select=“graph”/>

</bookOfPoems>

</xsl:template>
<xsl:template match=“graph”>

<graph style=“VisGraph”>

<xsl:apply-templates select=“vertex”/>
<xsl:apply-templates select=“edge”/>

</graph>

</xsl:template>
<xsl:template match=“vertex”>

<vertex style=“VisVertex”>

<name><xsl:value-of select=“name”/><name>
<x><xsl:value-of select=“x”/></x>
<y><xsl:value-of select=“y”/></y>

<.vertex>

</xsl:template>
<xsl:template match=“edge”>

<edge style=“VisEdge”>

<from><xsl:value-of select=“from”/></from>
<to><xsl:value-of select=“to”/></to>

</edge>

</xsl:template>

</xsl:stylesheet>

Document 206, is then written in a visualization language and comprises:

<?xml version=“1.0”encoding=“UTF-8”?>
<bookOfPoems style=
“VisTabs”xmlns:xsi=“http://www.w3.org/1999/XMLSchema-
instance”>

<graph style=“VisGraph”>

<vertex style=“VisVertex”>

<name>A</name><x>352</x><y>180</y>

</vertex>
<vertex style=“VisVertex”>

<name>G</name><x>94</x><y>160</y>

</vertex>
<vertex style=“VisVertex”>

<name>B</name><x>377</x><y>159</y>

</vertex>
<edge style=“VisEdge”><from>A</from><to>B</to></edge>
<edge style=“VisEdge”><from>A</from><to>G</to></edge>

</graph>

</bookOfPoems>

The representation of this document 206 to the user is illustrated within FIG. 3. Here 300, 304, and 308 are the visualization of Vertices B, A, and G respectively as described above and 302 and 306 are the visualization of edges “from A to B” and “from A to G” respectively as described above. Furthermore, 310 is the visualization of the area upon which the vertices and edges of the graph are drawn.

When a user edits the representation of the document 206 within step S208, preventing an illegal edit can be supported through a user interface as illustrated within FIG. 4. Here, 402 denotes a pop-up menu that allows only those actions that can be retranslated through the inverse style sheet 212. An other possibility is to omit those actions of a user that can not be retranslated through the inverse style sheet 212. Yet, an other possibility is to indicate to a user that the current graph is not well formed and that a user still has to perform additional editing actions in order to comply. This is illustrated within FIG. 5, where vertex A 304 is deleted and indications 500 and 502 inform the user of the invalid situation.

Then, when the inverse style sheet document 212 comprises:

<?xml version=“1.0”?>

<xsl:stylesheet xmlns:xsl=“http://www.w3.org/1999/XSL/Transform”

version=”1.0”>

<xsl:template

match=
“*|@*[not(name( )=‘style’)]|comment( )|processing-instruction( )|text( )”>

<xsl:copy>
<xsl:apply-templates

select=
“*|@*[not(name( )=‘style’)]|comment( )|processing-instruction( )|text( )”/>

<xsl:copy>

</xsl:template>

</xsl:stylesheet>

and is applied to the edited document 206 from which vertex A 304 is deleted, the resulting document 216 comprises:

<?xml version=“1.0”encoding=“UTF-8”?>

<bookOfPoems xmlns:xsi=
“http://www.w3.org/1999/XMLSchema-instance”>

<graph>

<vertex><name>G</name><x>94</x><y>160</y>

</vertex>

<vertex><name>B</name><x>377</x><y>159</y>

</vertex>

<edge><from>A</from><to>B</to></edge>
<edge><from>A</from><to>G</to></edge>

</graph>

</bookOfPoems>

From the described example above, respective rules apply for addition or any other kind of updates performed upon the vertices and edges. Within the above described general overview of the main steps according to the invention, the integrated user interface for visualization and editing provides attractive visualization. This means that the user interface preferably serves as the access point to the XML documents and the visualization information. To maintain exchangeability of XML documents, the resulting XML document must still enable validation. Validation requires the ability to retrieve back clean XML documents that have already been embedded with visualization information. Clean XML documents must adhere to an agreed schema as recommended by the W3C consortium, while the visualization language used can be proprietary. Therefore the need for an inverse style sheet, which is able to clean up the visualization information comprised within the XML document.

When a user performs an update upon an XML document by editing the interactive visualization that is produced by the visualization classes, the corresponding visualization class for the user's update is identified. The visualization class that is responsible to handle the update accesses its XML element in the DOM tree and applies the update to the visualization so that the user can view the performed update.

The method according to the invention can be implemented with the following software architecture. This software architecture comprises the following components:

a, so called, Domain Object Model (DOM) parser that reads the XML document 200, and optionally checks for its well-formedness, and produce an intermediate in-memory DOM tree of the XML document 200.

an XSLT performer that reads in the XSLT document 204 and the intermediate in-memory DOM tree of the XML document 200. Then, it combines the two documents into a new DOM tree document 206 that comprises the visualization information comprised within a “style” attribute that is attached for each element and indicates the visualization class of the corresponding element.

an analyzer that analyses the new in-memory DOM tree representation 206 and assesses the value of “style” attributes. This value refers to a visualization class' name that is responsible to create the graphical object for the corresponding element and lays it out on a computer's screen. If the “style” attribute is not present, the analyzer can instantiate a visualization class that is responsible to visualize the element with a default visualization.

For example, given the following in-memory document representing a book of poems and comprising the “style” attribute:

<?xml version=“1.0”encoding=“UTF-8”?>

<bookOfPoems style=“VisBook”

xmlns:xsi=“http://www.w3.org/1999/XMLSchema-instance”>

<poem style=“VisPoem”>

<title>Flirting Poem</title>
<line style=“VisLine”>Roses are red,</line>
<line style=“VisLine”>Violets are blue.</line>
<line style=“VisLine”>Sugar is sweet,</line>
<line style=“VisLine”>and so are you.</line>

</poem>

<bookOfPoems/>

Then, the XSLT performer construes a new in-memory DOM tree as illustrated within FIG. 6. Here, 600 illustrates the root-node “bookOfPoems”, 602 illustrates its child “poem”, while 604, 606, 608, 610, and 612 illustrate the children of 602: “title” and the four declared “lines”. The leafs of the tree are 614, 616, 618, 620 and 622 wherein 614 comprises the contents of label “title” being “Flirting poem” and 616, 618, 620, and 622 comprises the contents of labels “lines” being “Roses are red”, “Violets are blue”, “Sugar is sweet”, and “and so are you” respectively. After the construction of this DOM tree, the analyzer starts analyzing it from the root element 600. It assesses the “style” attribute of “bookOfPoems” and instantiates a “VisBook” class accordingly that is designed to visualize the root element 600. The subtree is then send back to the XSLT performer that recursively instantiates the corresponding class for the new root node(s) of the subtree. Each of the visualization classes is specifically designed to handle a certain kind of element. A visualization class comprises at least a subset of the following knowledge:

visualization properties;

the element it is visualizing in terms of the element's “style” attribute.

Furthermore, each visualization class comprises at least a subset of the following behavior:

stores the element that is passed to it by the analyzer;

creates the graphical objects for the element its holding;

sets the layout for its child elements or printing out its text value;

iterates the children of its element using the DOM Application;

visualizes its passed content by for example iterating its children recursively or pass visualization to an other class.

Programming Interface and sends each child element to the analyzer for visualization. Then, after a user edits the visualized document, the edited in-memory DOM tree document 210 is read by the XSLT performer which cleans the DOM tree document 210 from the “style” attribute by applying an inverse XSLT style sheet to the DOM tree document 210. The resulting clean in-memory DOM tree document can then be translated back to a clean XML document 216.

Throughout the embodiments, XML and related style sheets are used as examples and are not intended to restrict a person skilled in the art. It will be apparent to the person skilled in the art that the same mechanism can be applied to other structured documents like the Extensible Hypertext Markup Language (XHTML), Synchronized Multimedia Integration Language (SMIL), Standard Generalised Markup Language (SGML), and other languages as recommended by the World Wide Web Consortium (W3C).

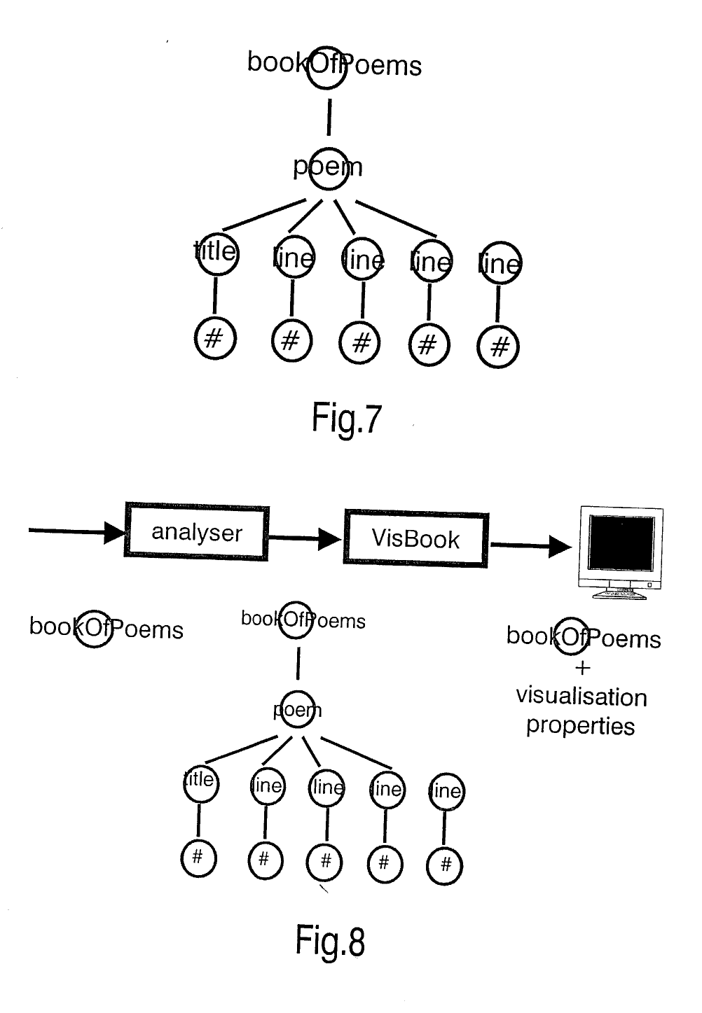

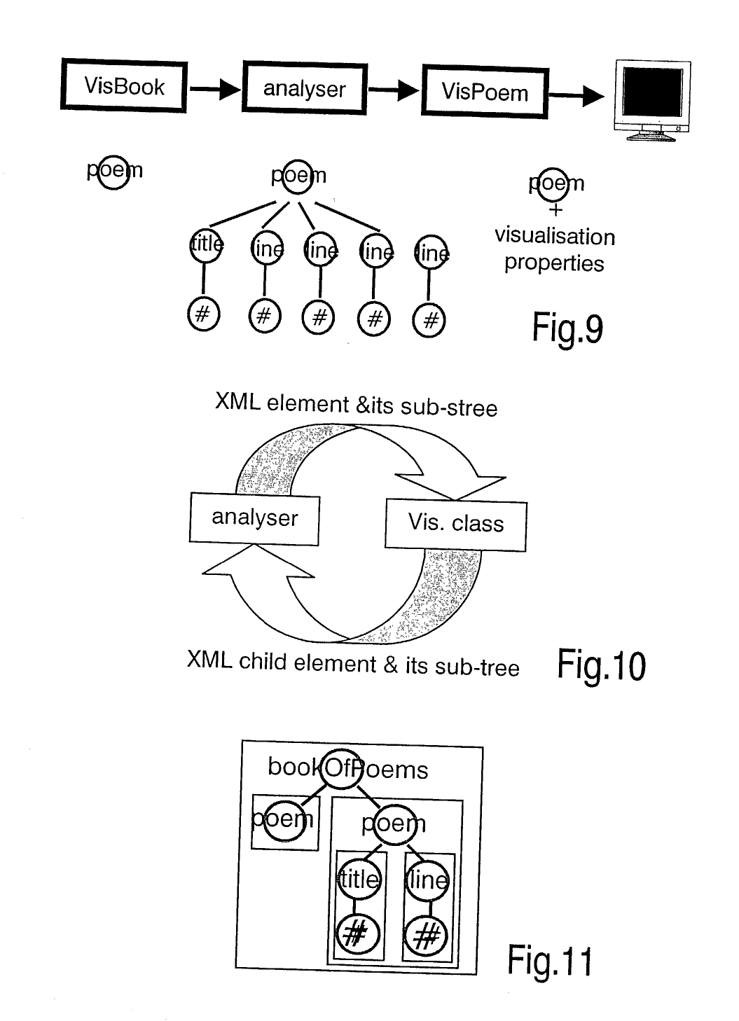

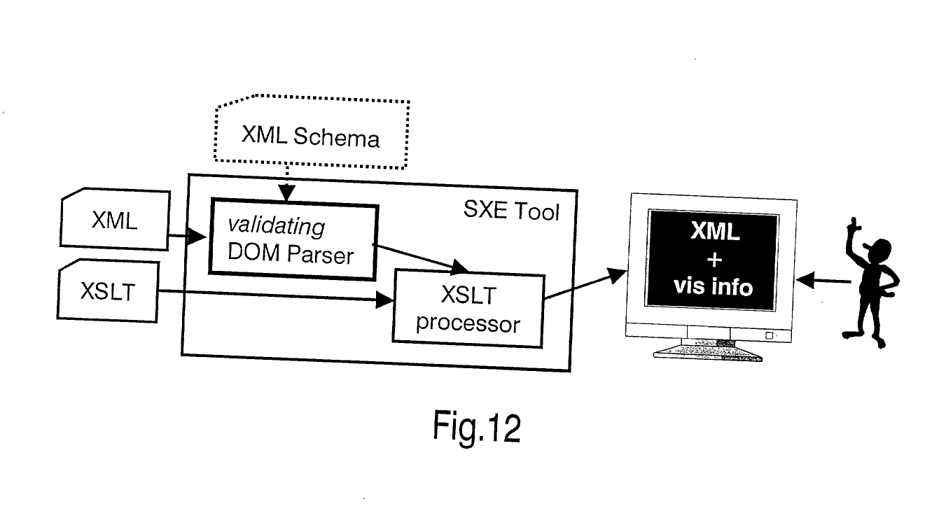

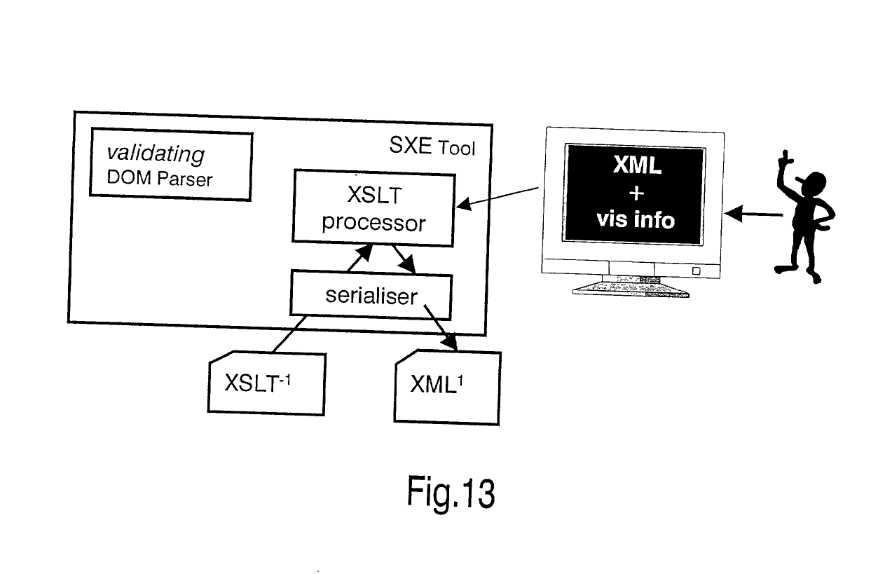

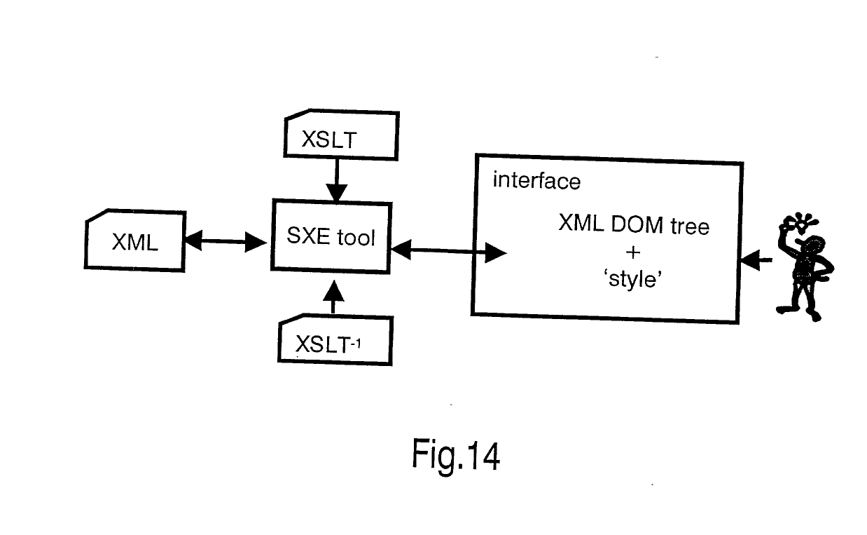

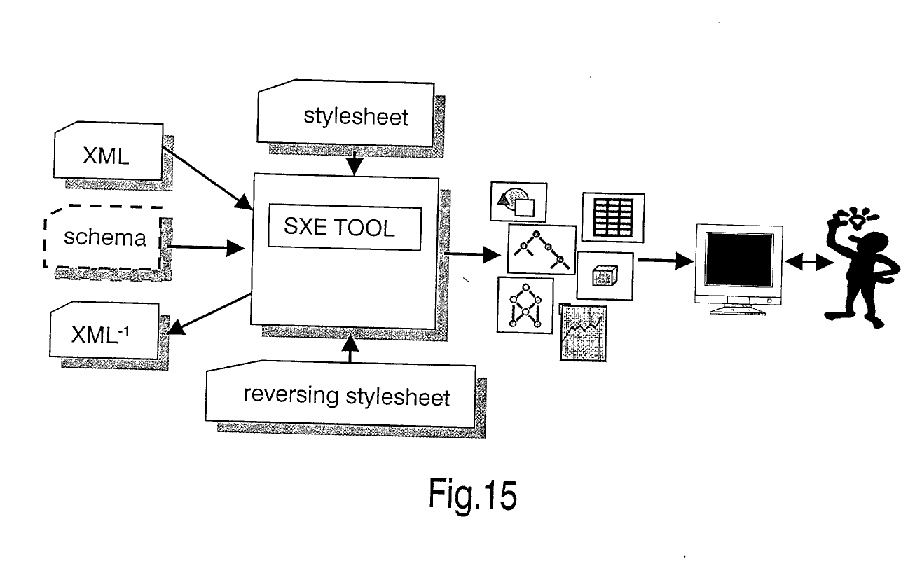

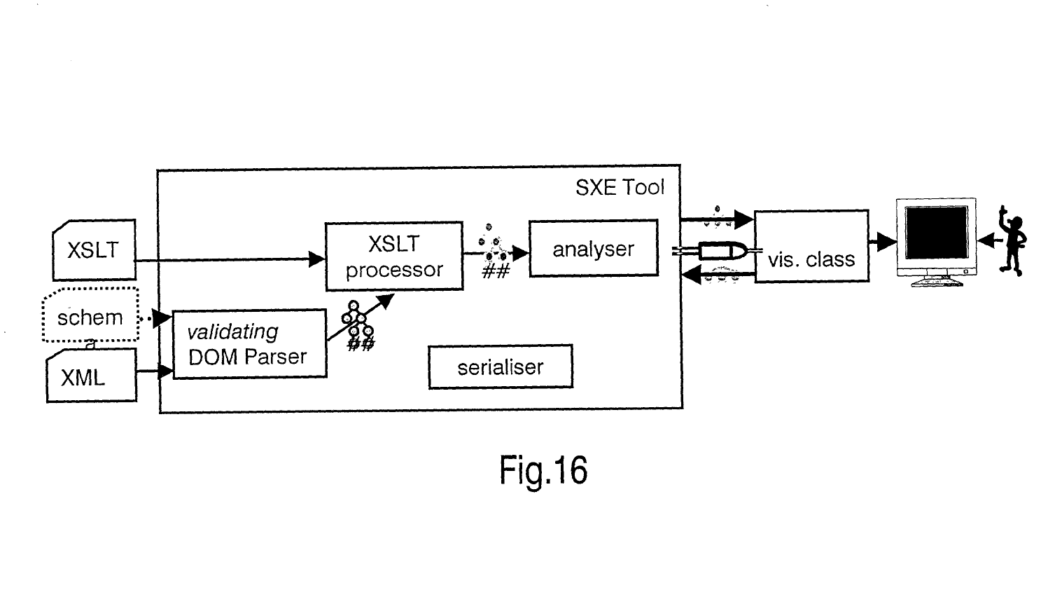

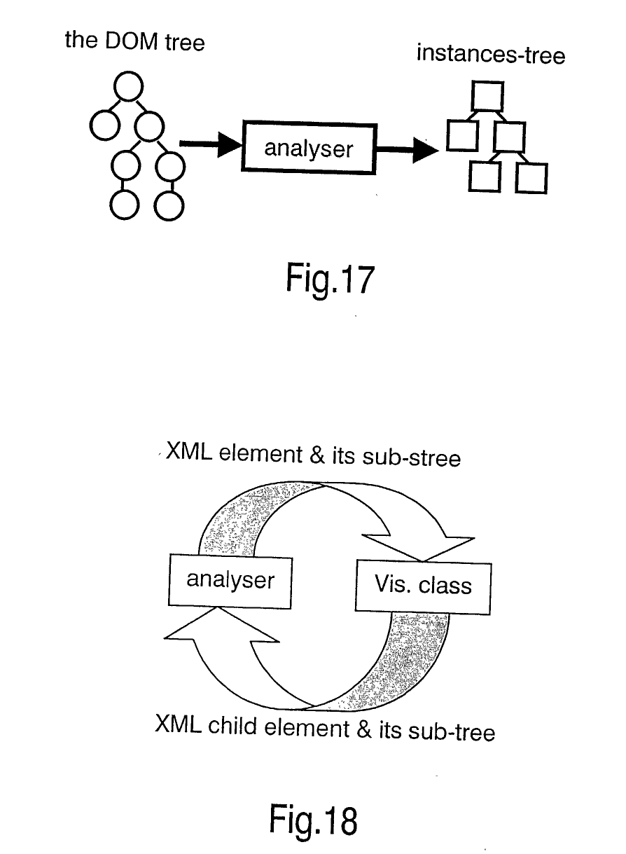

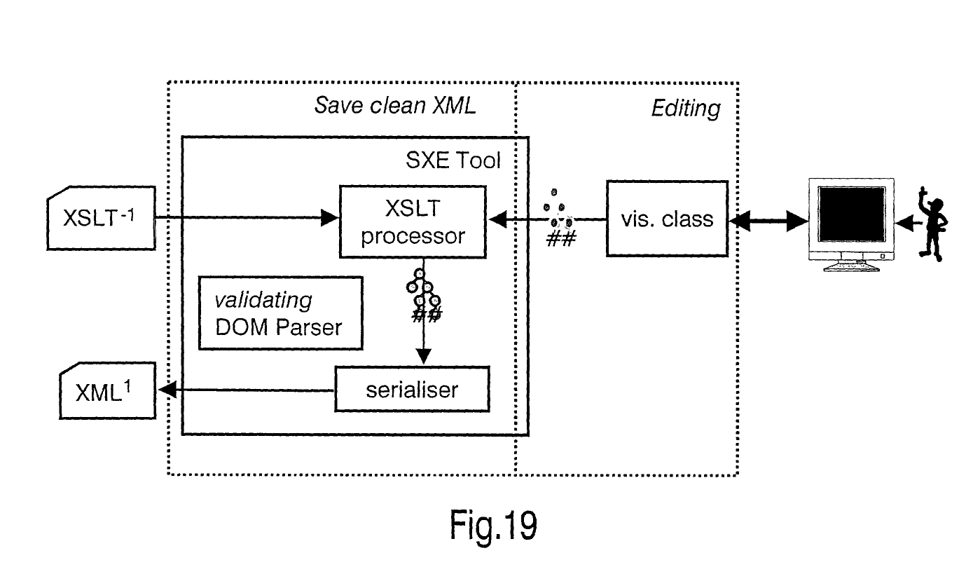

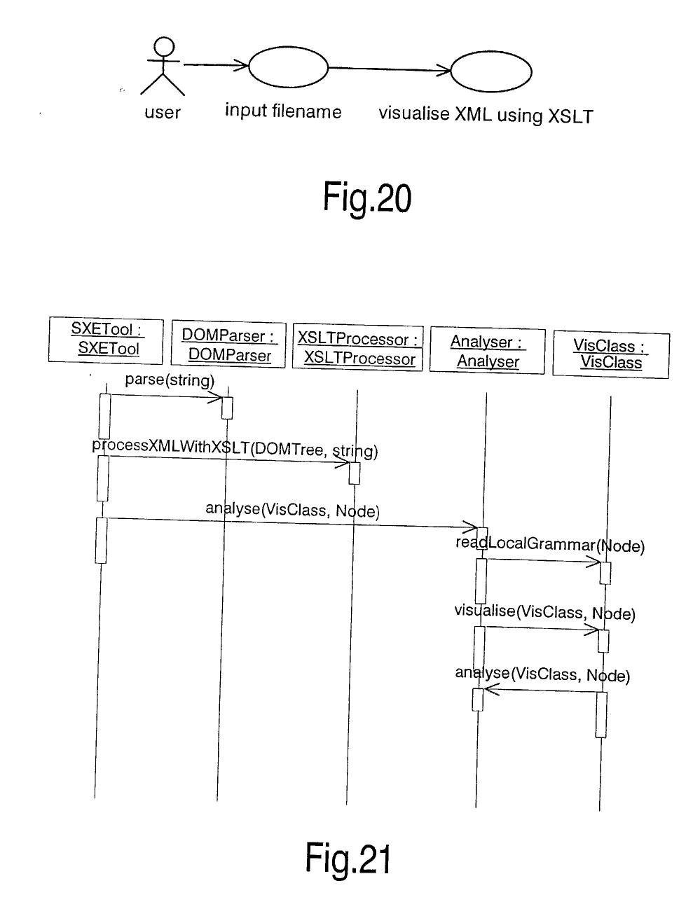

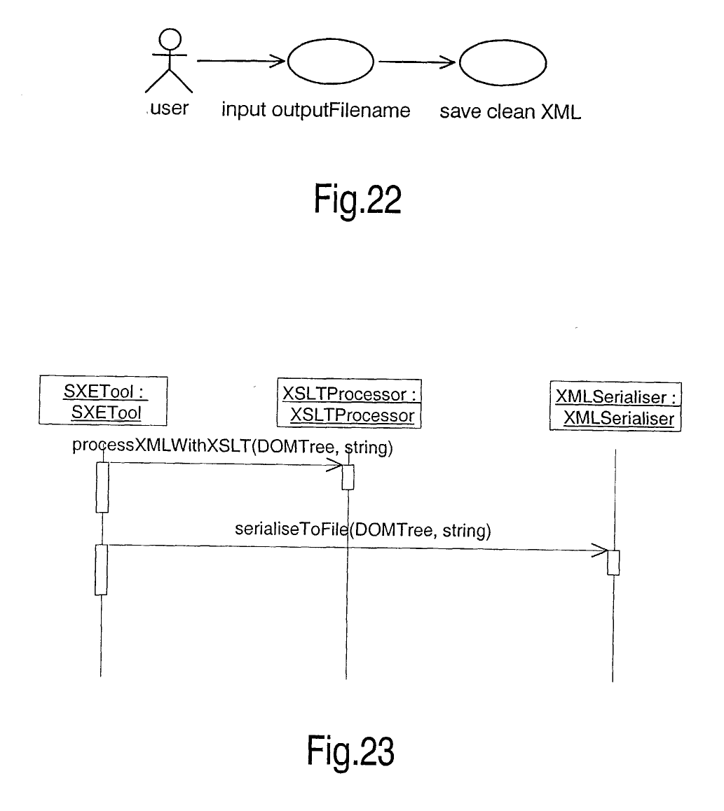

FIG. 7 illustrates an apparatus comprising an embodiment of a system according to the invention in a schematic way. The apparatus 718 comprises the system 700, a Central Processing Unit (CPU) 714 and a software BUS 722. The system comprises memories 702, 704, 706, and 708. The memories are operatively connected to the CPU 714 via the software BUS 722. The apparatus is further connected to a display screen 712 and to a user interaction device like a mouse 710. Furthermore, the apparatus is connected to a reading device 716. Memory 702 comprises computer readable code designed to convert an XML document into a DOM tree document as previously described. Memory 704 comprises computer readable code designed as a driver to convert user interaction performed by a user through for example the connected mouse 710 into update actions performed upon a visualized DOM tree document. In stead of a mouse 710, other input devices can be used too like a keyboard, keypad, touch-screen and the like. The DOM tree document is shown to the user onto screen 712. Memory 706 comprises computer readable code designed to incorporate the update actions into the DOM tree and memory 708 comprises computer readable code designed to reconvert the DOM tree that comprises the update into a clean XML document again. The computer readable code can be downloaded into the apparatus via the reading device 716, for example a CD reader that is connected to the apparatus. This CD reader will then read the computer readable code from a suitable storage device 720 like a CD that comprises this code. Other reading devices with their corresponding storage devices can be used too, like a DVD reader with a DVD, a floppy disk reader with a floppy disk etc. It is also possible to download the computer readable code from the internet in which case the apparatus 718 must be connected to the internet either wired or wire-less.

The memories are illustrates as separate memories, but can also be joined into one memory that is partitioned into separate pages comprising the respective computer readable code. The apparatus can be a personal computer, network computer, digital television set, set-top box, etc.

1. A method of updating a first document in a first format, the method comprising:
converting the first document in the first format into a second document in a second format;
displaying the second document to a user, wherein the second document is a visualization of the first document
characterized in that the method further comprises
editing the second document by performing a user interaction with the document;
updating the second document of the second format with the user interaction; and
reconverting the updated second document into an updated first document by inverting the updated second document.

2. A method of updating a first document of a first format according to claim 1, wherein the step of reconverting further comprises preserving a predefined interaction rule defined by the first document by filtering an update that violates the predefined interaction rule.

3. A method of updating a first document of a first format according to claim 2, wherein the step of updating the second document further comprises preserving the predefined interaction rule defined by the first document by not allowing an update that does violate the predefined interaction rule.

4. A method of updating a first document of a first format according to claim 1, wherein
the first document is an XML document and the first format is described within a separate XML stylesheet that describes the visualization of the first document;
the second document is the visualized first document with its second format according to the XML stylesheet that describes the visualization of the first document; and
the step of reconverting the updated second document comprises applying an inverse XML stylesheet that describes the conversion of the visualized first document into the first document and the separate XML style sheet.

5. A method of updating a first document of a first format according to claim 2 and 4, wherein filtering the update further comprises applying a rule comprised within the inverse XML stylesheet that filters the update that violates the predefined interaction rule.

6. A method of updating a first document of a first format according to claim 3 and, wherein allowing the update further comprises providing to the user a predefined non-violating update that a user can perform.

7. A system of updating a first document of a first format, the system comprising:
converting means conceived to convert the first document of the first format into a second document of a second format, wherein the second document is a visualization of the first document
characterized in that the system further comprises
updating means conceived to update the second document of the second format according to the user interaction; and
re-conversion means conceived to reconvert the updated second document into the first document by inverting the updated second document.

8. A computer program product designed to perform the method according to claim 1.

9. A storage device comprising the computer program product according to claim 8.
